(19) United States
(12) Patent Application Publication
(10) Pub. No.: US 2009/0240424 A1
(43) Pub. Date: Sep. 24, 2009

(54) Open community model for exchanging information in dynamic environments

(75) Inventor: Frederick Hayes-Roth, Atherton, CA (US)

Correspondence Address: LUMEN PATENT FIRM, 350 Cambridge, Suite 100, PALO ALTO, CA, 94306, US

(73) Assignee: The Hayes-Roth Family Trust

(21) Appl. No.: 12/455,003

(22) Filed: May 26, 2009

Related U.S. Application Data
(63) Continuation of application No. 10/678,607, filed on Oct. 3, 2003.

(51) Int. Cl. G08G 1/0967; G06F 17/00; G01C 23/00; G01C 21/34; G06N 5/02

(52) U.S. Cl. 701/119; 701/121; 701/122; 701/206; 701/210; 706/52

(57) ABSTRACT

An open community model for information exchange enables individuals to plan and attain superior outcomes in a dynamic environment. A continually “world model” maintains information about the dynamic environment that is valuable for individuals of the open community. An open community model application publicizes a specification of relevant types of information it receives from suppliers and provides to consumers. Suppliers provide information consistent with the specification. Consumers utilize received information to reduce uncertainties or errors in the assumed environment so they can generate improved plans or improve their expected outcomes. Consumers give feedback to the open community model about the quality of information they received. A “world model” application combines information received to update and improve its understanding of the dynamic environment and its estimates of relevant parameters. The community model simplifies the creation and operation of information markets where innovative products are naturally selected and economically reinforced.

### CROSS-REFERENCE TO RELATED APPLICATIONS

This application is a continuation application of U.S. non-provisional application Ser. No. 10/678,607 filed Oct. 3, 2003, which is incorporated herein by reference.

### FIELD OF THE INVENTION

This invention relates generally to exchanging information in dynamic environments. More particularly, it relates to a new and useful open community model application, system and method for members and non-members of the community to exchange desired information in a timely, efficient, and effective manner particularly useful in generating plans.

### BACKGROUND OF THE INVENTION

Individuals need current information beyond their purview to generate and optimize their plans and to achieve the best possible results from executing these plans. This means that information about the environment beyond the view of each individual is needed for that individual to achieve successful planning. For this reason, various systems exist to provide information about local/distant regions of a domain or environment in which an individual would want to plan or to execute a plan. The best examples of such systems are ground vehicle route planning systems such as one shown in FIG. 1. A ground-based route planning system 100 includes a center 101 for processing traffic related data gathered from sources 110₁-110ₘ. The center 101 provides to subscribing consumers 120₁-120ₙ, such as route planners, information about available route segments and expected velocities along those segments. Using this information and with a commercial route planning software program running on a computer (not shown), a subscribing route planner can generate and evaluate candidate plans (routes and time) for some desired travel, and then select the one that would achieve the best results, i.e., expected outcomes, in terms of, for example, total time, total distance, or total cost. As illustrated in FIG. 1, the ground-based route planning system 100 is architecturally designed to exclude outside or non-conforming information suppliers 310₁, 310₂, . . . , 310ₘ as well as outside or non-subscribing information consumers 320₁, 320₂, . . . , 320ₙ.

Many new systems are becoming available under the rubrics of location-aware computing, mobility and pervasive computing that enable individuals to consume information relevant to their plans and also to provide information about plans or plan execution. For example, global positioning system (GPS) enabled route planners and moving-map route followers enable an individual to enter a route through a user interface, to observe one's own progress on the planned route as one travels, and even to report attained velocity along the route. The totality of the computation and communication may be distributed in the individual's vehicle among other devices, including a PC or a PDA, and involving wireless communication via the Internet or other network. FIG. 2 shows a GPS-enabled route planning system 200 which includes a center 201 for processing traffic related data gathered from sources 210₁-210ₘ. The center 201 provides route related information to subscribing consumers 220₁-220ₙ. Similar to the ground-based route planning system 100, the GPS-enabled route planning system 200 is architecturally designed to exclude outside or non-conforming information suppliers 310₁, 310₂, . . . , 310ₘ as well as outside or non-subscribing information consumers 320₁, 320₂, 320ₙ.

In all current planning systems, the only information fed back to the system from an individual is about the position and velocity of that particular individual. No other information can be provided directly back to the system. For example, in the GPS-enabled route planning system 200, the subscribing consumer 220₁ can report his attained velocity to the system 200; however, the system 200 does not enable nor does it allow him to make other relevant observations, describe them, encode them in an acceptable syntax, and convey them back to the system. Indeed, although little dynamic information can sometimes be collected, usually automatically, from sensors, in known planning systems information primarily flows from a centralized environment model database to individual planners and plan executors. In other words, the information flow in most current systems can be characterized as unidirectional with well-defined parameters. Such closed system architecture allows for easy integration and dissemination of information. Therefore, it would be counter-intuitive and counter-productive to modify or redesign these current closed-type systems so as to enable individuals to contribute their respective observations about the dynamic environment, to enable individuals to rate or evaluate the quality and usefulness of information received, or to allow for various types of information feedback and ways to use that feedback.

Consequently, one of the greatest possible sources of dynamic, reliable and innovative information is excluded, namely, observations of the dynamic environment contributed by travelers, drivers, pilots, or other participants of the system such as a plan executing agent. This means that existing planning systems are limited in type of information as well as in completeness, accuracy, and timeliness of material information. From the supply side, suppliers might have innovative types of information that cannot readily be integrated into existing systems. From the demand side, planners might have a variety of objectives and concerns that also cannot easily be incorporated into existing systems. Under these circumstances, today's individuals live, travel, plan and execute plans in their communities, but these communities, lacking open standards and mechanisms, do not effectively cooperate to share current information.

Many networks have been built to disseminate situation data to participants. Good examples include network-based services that disseminate information on current traffic problems in cities or estimated times of arrivals of airline flights. These networks deliver information to end users in a variety of multi-media formats such as graphics, images, text, audio, and video. Such multi-media information is generally used ad hoc, meaning that each individual who accesses the information is expected to read and interpret it, with little more insight into how the information is used or how the information might be altered to optimize the recipients' expected outcomes. It is not to be utilized by computational procedures that are common to individual members of a cooperative community. On the other hand, information or data used by a computational procedure is usually quite specific and proprietary, rather than open and extensible.

Recently, several companies and municipalities announced new systems capable of offering near-real-time information on traffic rates and impediments, such as accidents. While the methods for collecting and analyzing relevant data differ, these systems send messages to individuals and their devices showing route segment outages and changes to expected segment velocities or expected latencies to traverse an affected route. In computing the revised model-based estimates, each of the systems utilizes a proprietary approach and analyzes only specific data received from a selected set of suppliers.

A clear drawback is that planners often engage in many different types of dynamic environments with various behaviors beyond the capabilities of these simple ground-based route-planning systems. These prior art systems are unable to provide relevant and reliable information for people who might need or want to plan other kinds of routes, such as aircraft flights and sea-going trips. For example, a family might need or want to plan longer itineraries for a trip to multiple locations over many days. A student might want or need to plan sequences of courses to take to achieve an educational goal. A health care professional might need or want to plan medical diagnostic and therapeutic regimens to address a medical problem. As the above examples illustrate, people need or want to plan courses of action that would take them through choice sets over time. A good plan is a set of timed actions or timed events that can be expected to optimize or nearly optimize the quality of the outcome attained relative to the costs expended and the risks incurred.

Unfortunately, there are no efficient and effective techniques or methods currently available to enable individuals to receive timely, relevant, and material information about the dynamic environments in which they are planning. As mentioned above, a few prior art systems have been created to provide a very limited amount of information about the environment; however, these systems are based on closed architectures with proprietary standards and highly restricted participation. For example, near-real-time traffic data for ground-based route planning just became available, but the approach employed there is highly specialized, architecturally closed, and not reusable by other domains, tasks, or dynamic environments. Even in the case of ground-based route planning, existing systems are limited by their closed, unidirectional nature. As a result, it is difficult to introduce new types of information into the existing systems, such as expected levels of precipitation and their effect on road traction, or Presidential motorcades and estimates of time, area, and impacts on various routes. Because there are potentially an infinite number of types of information that may be material to some planners and because people are as dynamic as the environments they are in, there is a need for a system that is adaptive to dynamic environments and open to new types of information, new suppliers, and new or augmented models that are readily accessible by interested parties.

### SUMMARY

The present invention addresses this need with a new and useful open community model. According to an aspect of the invention, the open community model is an application that maintains a world model based on information received from suppliers and provides valued information to consumers. The model estimates states and parameter values of a dynamic environment. The community participates in supplying and consuming information from the open community model. The open community model can be extended easily to adapt and incorporate new types of information. It is open to new suppliers and new consumers of information and provides a standardized open forum for suppliers and consumers to represent and exchange information. The term “open” dictates that shared standards determine the requirements for exchanging information in the open community model. “Open” also requires that the open community model does not bar new potential qualified participants from joining in if they wish to. “Open” further requires that the open community model enables some new participants to readily join in or that existing suppliers can readily provide new information products to existing community consumers. The more easily potential participants can join, the more “open” the open community model will be. The open community model makes it easy to evolve new types of information and to specialize what information is provided to various consumers. The open community model allows individuals to be at the same time both suppliers (producers) of information and consumers of information, or information prosumers. That is, the current invention essentially provides a closed-loop but open system of an unlimited number of participants. In the most natural form of the invention, each participant is a prosumer, simultaneously producing and consuming information.

To be useful and efficient, an information supplier must address each information consumer's need to know. It must reduce uncertainty or error in a variable that, in turn, enables the recipient to make the best possible plans, ones that minimize costs while maximizing outcomes. To imbue information with value, that information should be relevant and material to the individual's plan. Some analysis is generally required to determine what type of information would be valuable, how valuable, and for what set of individuals. Individuals would need to describe the information they need and motivate or entice others to supply it. Further, to convert information from potentially valuable to actually valuable requires that some recipients receive information, digest it, and actually utilize it. Thus, the most valuable unit of information could be one that modifies a pre-existing expectation in a significant way, or one that impacts a large number of individuals in ways that are likely to cause them to modify their plans or in ways that would result in significant changes in the outcomes they experience, compared to what they would have experienced if they had not received the information and re-planned accordingly.

The current invention advantageously utilizes recent advances in the Internet and World Wide Web Consortium (W3C) standards to provide an open architecture to support the exchange of standardized information among suppliers and consumers about a dynamic environment so that individuals can plan and execute plans that attain the highest possible levels of desirable outcomes. Information about the dynamic environment that is valuable for individuals is maintained in a continually evolving information base or “world model.” The type of information required is determined by considering the types of plans the individuals must produce and the types of information they are sensitive to. The open community model publicizes a description of the relevant types of information it receives from suppliers and provides to consumers. The suppliers provide information consistent with this specification. A “world model” application combines information supplied to it to update and improve its understanding of the dynamic environment and its estimates of relevant parameters. Consumers receive information from the world model encoded in a manner consistent with the standards specified.

The consumers utilize the received information to reduce uncertainties and/or errors in their beliefs about the environment so that they can generate the best possible plans or improve their expected outcomes. This enables them to achieve the highest possible levels of adaptive behavior. The consumers can give feedback to the open community model about the quality of information they received, about the kind of information they desire, or about the value of various types of information for them. The open community model can assess the quality of suppliers as well as their information, can compensate them for the quality of type of information they provide, and can determine the value of information for a potential consumer. By providing open standards for information exchange, the open community model makes possible the evolution of an efficient, effective and diverse information exchange mechanism that enables individuals to reduce costs and obtain best possible outcomes while adapting to a wide variety of behaviors in different dynamic environments.

An object of the invention is to make it possible to exchange timely, useful, reliable and desirable information about dynamic environments in an efficient and effective manner. The invention provides means for individuals to assign value to information, to pay for valued information, and to entice and reinforce suppliers who provide valued information. The open community model provides means for individuals to assess the quality, value, and usefulness of information received, and means for collecting, processing, and transmitting individuals' feedback about suppliers and the information they have supplied.

Another object of the invention is to enable individuals who consume information to become suppliers of information, either information about the environment, themselves, or about information they desire or received from suppliers.

Yet another object of the invention is to make possible multiple specialized open community models, addressing different environments, tasks, objectives or concerns. Each open community model is based on domain-specific standards relevant to a particular set of tasks, objectives and concerns in a category of environment. Thus, different open community models can be customized for different sets of suppliers and consumers for different domains.

A further object of the invention is to solve planning and optimization problems in virtual or digital environments where members of the open community model may include computer agents, in addition to human members. Each computer agent might be a supplier, a consumer, or prosumer. Each computer agent might be a planner or a plan executor acting on behalf of a human or computer-based planner.

Another object of the invention is to provide a solution to the problem of achieving effective meta-planning in distributed environments, where multiple suppliers and consumers exist for meta-level information, such as information about information (its quality, value, timeliness), information about priorities, information about limited processing or communication resources. The open community model provides a solution both for this meta-level problem and for the base-level problem being addressed such as route planning or itinerary planning.

Another object of the invention is to solve analysis, planning and adaptive response problems in domains very different from land-based route planning systems. The open community model provides the structures, mechanisms, and approaches required to organize an effective community response to the challenges of sharing material information about a dynamic environment with those who need it and evolving an improved set of standards, suppliers, and information through time.

Another object of the invention is to foster creation of specific open communities, specialized in performing exchange of information at high levels in various dynamic environments. The open community model provides structures, mechanisms, and approaches that make it possible to enlist a particular set of suppliers and a particular set of consumers as participants in a particular open community. Again, the “openness” of the system disclosed herein is based on the open information encoding standards, especially XML. An innovative concept embedded in the open community model is the integration of such open standards plus the world model that continually updates estimates of the dynamic environment, intelligently and selectively assessing and adopting timely reports/submissions conveyed through the open standards. The invention enables all authorized participants (members) to experience all the benefits of participating in an open community. Qualified potential participants (non-members who have the qualities the community requires of its participants) could be accommodated appropriately as well, with limited privileges. On the other hand, the “openness” needs not be literal. By means of secrecy, encryption, or other security mechanisms, unqualified non-members could be excluded from submitting information to the open community model or accessing valued information stored in the model. An example of an open and yet exclusive community model would be one that is implemented with virtual local area networks (Virtual LANs), which adopts open standards of TCP/IP but assigns encryption keys to a sub-community. This open-yet-exclusiveness can be very useful in preventing unwanted information such as “spam” from entering into the system.

Still further objects and advantages of the present invention will become apparent to one of ordinary skill in the art upon reading and understanding the drawings and detailed description of the preferred embodiments disclosed herein.

### BRIEF DESCRIPTION OF THE DRAWINGS

FIG. 1 shows an architecturally closed ground-based vehicle route planning system.

FIG. 2 shows an architecturally closed GPS-enabled vehicle route planning system.

FIG. 3 presents key components of an open community model according to an aspect of the invention.

FIG. 4 shows an embodiment of an information exchange mechanism between individuals and the world model.

FIG. 5 schematically shows an embodiment of the invention having distributed sub-models maintaining a world model and information base relevant to their areas of responsibility.

FIG. 6 depicts an intelligent object implementing an embodiment of the present invention.

FIG. 7 shows an embodiment of the open community model in which specialized intelligent objects are proliferated to support all or many individuals and sub-models of the open community model.

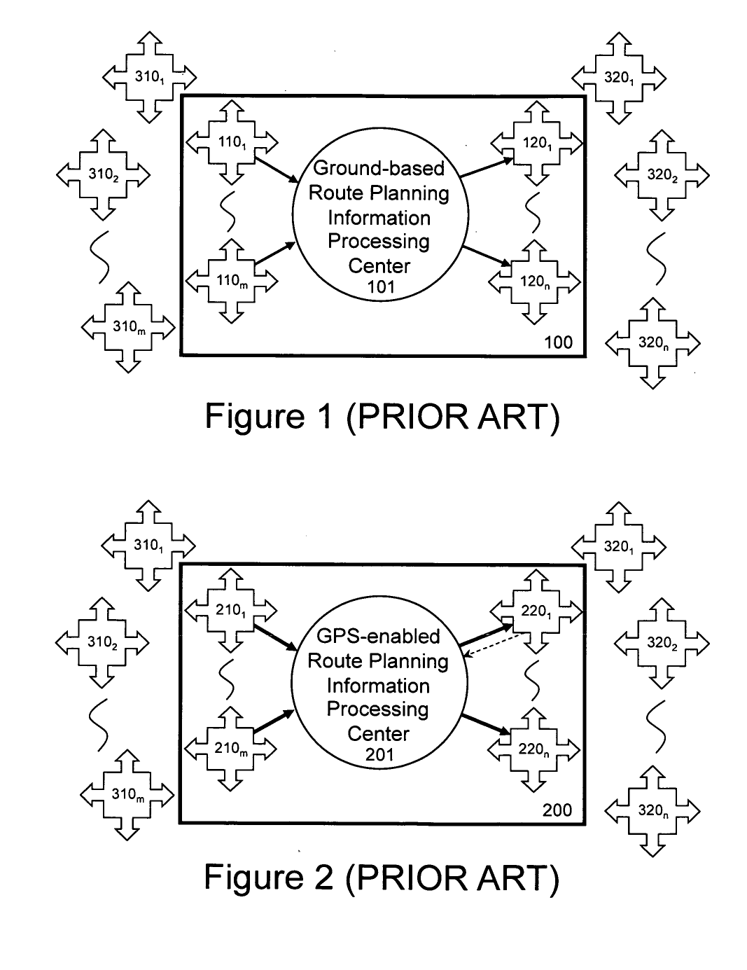

### DETAILED DESCRIPTION

While the Internet has provided a means of connecting many individuals and the World Wide Web Consortium (W3C) standards have provided certain means for describing what kind of information is in a text document, these technologies themselves do not create or maintain near-real-time models of dynamic environments nor make these models accessible to interested parties such as planners. On the other hand, without these standards, the vast number of planners will be unable to obtain the information they need from the largest number of most qualified suppliers. But for suppliers to know what type of information they should be providing, they will need to participate in some kind of an open community where individuals who use the supplied information for planning and executing are able to provide descriptions of needed or desired information and provide feedback on the quality and usefulness of the information provided by the various suppliers. Several barriers exist today that impede such an open and adaptive community.

The chief barrier to the emergence, evolution, and success of information sharing is the lack of usable open standards for information models of dynamic environments and the lack of a concomitant community of suppliers and consumers operating in a manner consistent with those open standards. Because of potentially infinite numbers of diverse environments, techniques are required to allow specialized communities. Moreover, because every community evolves over time, any open standards and methods adopted would need to also evolve over time. Furthermore, because communities may not agree unanimously about what types of information are needed or how valuable they are, the communities will need to adopt methods, applications, and systems that allow evolution and reinforcement of preferred alternatives within a set of several acceptable approaches. This means that each community must permit a multiplicity of standards and incorporate methods of assessing and reinforcing preferred models of the environment, preferred suppliers of information, and preferred types of information. In many practical contexts, this will necessitate ways of economically rewarding preferred suppliers for preferred products. In short, the community model that enables individuals to improve their performance must evolve through an artificial form of natural selection. Alternatively, we can say that an open community model must have some type of competitive market or adaptive selection process for information products about dynamic environments.

The type of information that is needed depends on the goals and context of the individuals who are planning or acting in the environment. On the flip side, the information provided to them should be extensible and responsive to their various needs. For example, if one traveler wants to avoid high temperatures (perhaps because his vehicle's air conditioner is broken, or for whatever reason), he may need to access information about sun exposure or en route temperatures. Another planner may have concerns about risks of delays, reliability of connections, or financial insolvency in the transportation carriers. Each planner has different needs and therefore would assign different values accordingly. Moreover, each new type of plan sensitivity might implicate a new type of information required. As discussed before, existing systems unfortunately are not capable of taking into consideration the sensitivities of each individual's plans to various types of information, and neither do these systems provide means for inferring those from their plans or extending their information supplied to address these sensitivity factors.

The current invention addresses the shortcomings of previous efforts by enabling individuals to adapt their behaviors based on near-real-time information about dynamic environments. The open community model disclosed herein provides an adaptive, open, extensible architecture for individuals to supply and consume desired information. The open community model comprises means for maintaining a situation model that individuals can refer to when evaluating potential plans. The model of the dynamic environment or situation model is referred to as the “world model.” The open community model incorporates an application that uses supplied information to update the world model information base and accesses relevant information in the world model to provide information valuable to individual consumers. Unlike previous systems, the current invention provides a means for all members of the community to supply and to consume information as well as a means for defining standardized forms of information associated with different types of information relevant to different types of behaviors. What is more, by adopting the Internet and W3C standards, participation in this community is significantly simplified.

More specifically, the world model is represented and encoded in an information base, which usually describes parameter values, perhaps with error estimates, that pertain at some time. The time may be in the past, current at the present moment, or in the future. Only certain descriptions of the past or present are without inherent uncertainty. Future values are termed expectations, and these may be inferred in various ways, such as through dead-reckoning, simulation, projection, or prediction. In some applications, there may be multiple alternative possibilities recorded in the information base, as when we know that an entity may be in one of two alternative states but do not yet know which one actually is correct.

In many community models, the world model will be explicit and centralized. This applies when the information base is stored in a conventional database. In such a case, one database management system (DBMS) stores all values of all parameters in a central store. The DBMS provides functions for query and update, as when SQL is used to query and update a relational database. Only data that conform to the constraints on the relational tables can be stored, providing some assurance of consistency and integrity. However, the consumers or suppliers of information for relational databases do not have to conform to an explicit semantic standard, which means that in general relational databases do not typically implement world models of the type community models require.

In simple applications of the open community model, the world model aggregates all information received from suppliers, because there is no redundancy or inconsistency. This would apply, for example, when different individuals provide prices on different commodities, applicable during non-overlapping time intervals. The world model of commodity prices in such a case would consist of the set of all information provided.

In more complex applications, information from multiple suppliers must be combined in some manner to eliminate redundancy and inconsistency. This applies, for example, when multiple suppliers are reporting different prices for the same commodity at the same time. In addition, it may be more useful for many consumers to provide to them summary statistics on variables of interest, such as the range of ask prices for commodities, or the mean and standard deviation of rainfalls reported in an area during a time interval of interest. The world model application computes the functions required to update its parameters based on new information updates. Well-known statistical means are generally used when appropriate to estimate parameters that identify a model for a particular variable of interest, such as price or rainfall.

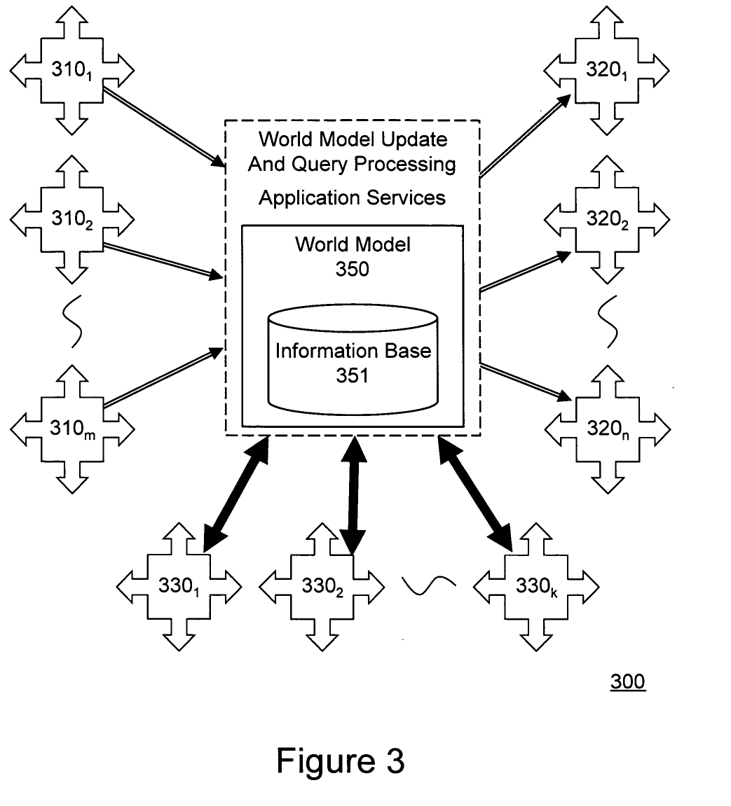

FIG. 3 describes the key components of an open community model 300, an application that maintains a world model 350 for receiving and processing information from suppliers 310₁, 310₂, . . . , 310ₘ and for providing valued information to consumers 320₁, 320₂, . . . , 320ₙ responsive to their sensitivities, perhaps as expressed through queries. Each open community model is intended to serve some set of potential suppliers and consumers, who can freely choose to join and share information products consistent with community standards. In some contexts, community membership might be restricted to all potential entities with common nationality, allegiance, or other relevant qualification. The term “open” dictates that shared standards determine the requirements for exchanging information in the open community model 300 so that new suppliers and consumers can join in. “Open” also requires that the open community model 300 does not bar new potential qualified participants from joining in if they wish to. “Open” further requires that the open community model 300 enables some new participants to readily join in or that existing suppliers can readily provide new information products to existing community consumers. The more easily potential participants can join, the more “open” the open community model will be. Some individuals may be both suppliers and consumers of information, and these are termed “prosumers” such as prosumers 330₁, 330₂, . . . , 330ₖ. The world model 350 is the knowledge/application that corresponds to a description of an environment/world/community and the community members' beliefs about states of that environment. In some embodiments, the world model 350 encompasses models, situations, plans, and expectations related to the environment and offers a current, complete, correct, and consistent view of the environment. Information base 351 is the representation of data and information on which the world model 350 depends. Since individuals are often mobile, communications between suppliers, consumers, and prosumers and the world model application 350 can be implemented in various ways, ranging from wired to wireless, from Internet to proprietary protocols.

In a preferred embodiment, each distinct community communicates to and from the world model using an eXtensible Markup Language (XML)-encoded information that conforms with the syntactic and semantic rules of a community Document Type Definition (DTD). With such an XML DTD, messages that contain information must explicitly conform to the syntax and semantic definitions of the DTD. Moreover, the XML-encoded data carries the annotations and attributes as part of the message so that any recipient can interpret the data's categories and semantics. This means that every supplier and consumer, as well as every prosumer, can interpret conveyed information in semantically consistent ways. In addition, the range of issues that each community can address is easily extendable by augmenting the DTD to permit new kinds of information.

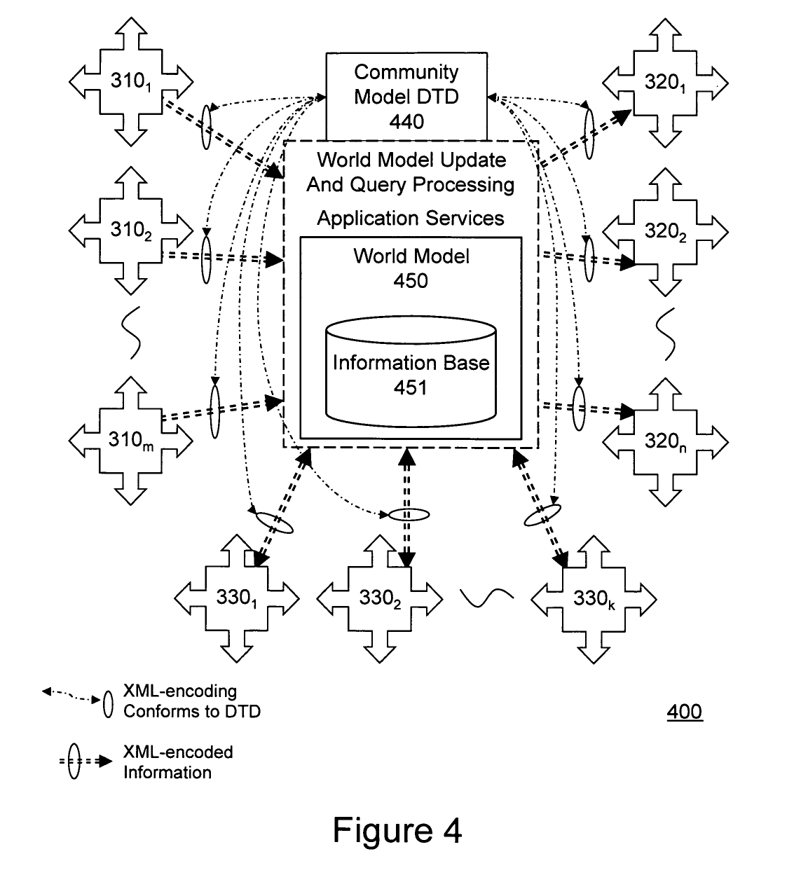

FIG. 4 shows that the open community model 400 benefits from adopting and sharing a common data dictionary or a community model DTD 440 that defines how to encode information communicated between a world model application 450 and individual suppliers 310₁, 310₂, . . . , 310ₘ, consumers 320₁, 320₂, . . . , 320ₙ, and prosumers 330₁, 330₂, . . . , 330ₖ. Information is then encoded in XML in a manner conforming to the DTD 440. This means that information exchanged is interpretable according to common syntax and semantics. Information received and retained is kept in an information base 451 for use by the world model application 450.

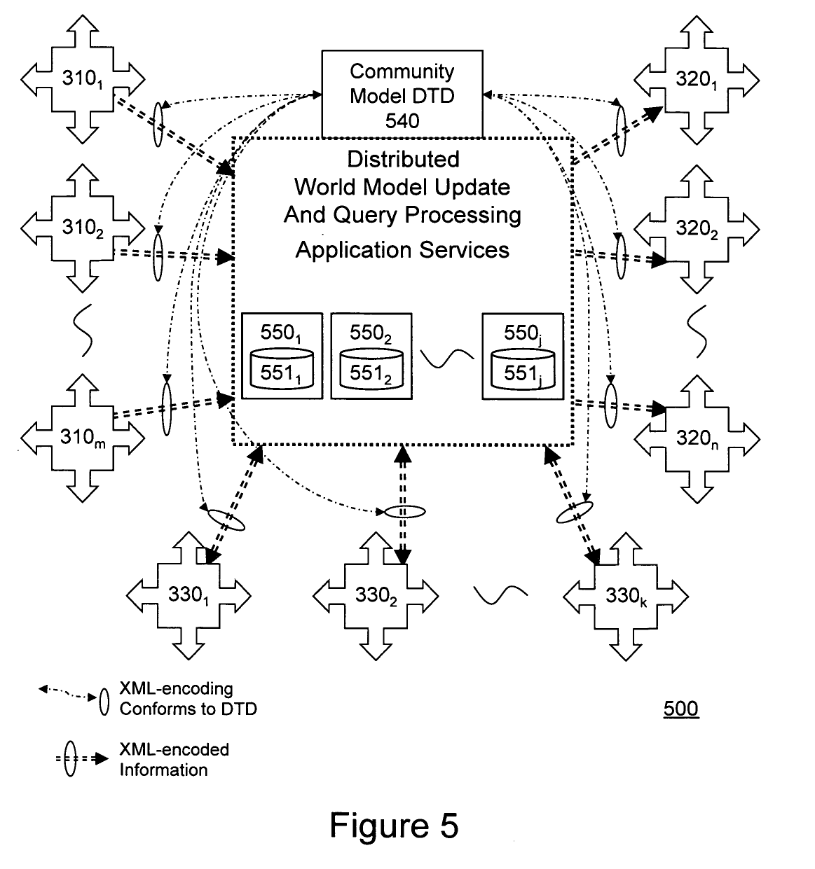

In an embodiment as shown in FIG. 5, the open community model 500 benefits in many environments from being physically distributed but conceptually global. The community model DTD 540 defines how to encode information communicated among the sub-models and individual suppliers 310₁, 310₂, . . . , 310ₘ, consumers 320₁, 320₂, . . . , 320ₙ, and prosumers 330₁, 330₂, . . . , 330ₖ. Information is then encoded in XML in a manner conforming to the DTD 540. Each of the distributed sub-models respectively maintains a world model 550₁, 550₂, . . . , 550ⱼ, each having a corresponding information base 551₁, 551₂, . . . , 551ⱼ, relevant to its respective areas of responsibility. Queries and updates are routed to appropriate sub-models and their corresponding applications. Each of the sub-models intermittently communicates with appropriate neighboring sub-models to reduce inconsistencies and to align their beliefs regarding environmental entities and properties. There can be some overlapping in the extent of neighboring sub-models to provide better overall cost-performance for query processing and updating.

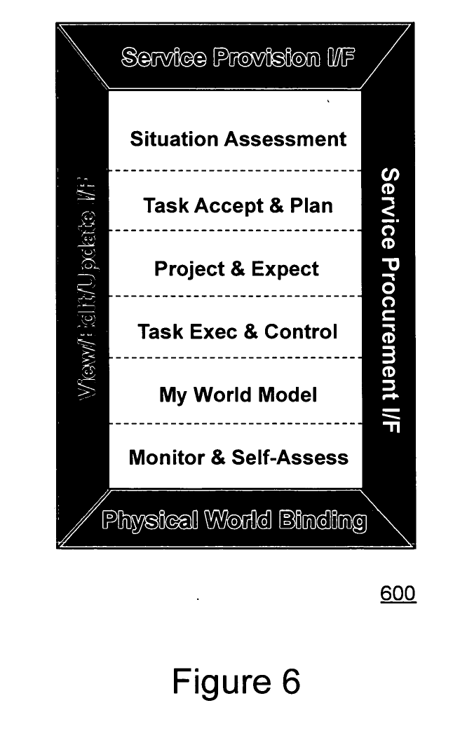

FIG. 6 depicts an intelligent object 600 for implementing an embodiment of the present invention. Basic intelligent object technology is known in the art and thus not further described herein. The intelligent object 600 according to the present invention is a computerized system capable of modeling some extent of an environment and the object's own behaviors in that environment. The intelligent object 600 can plan to perform tasks and execute such plans, can monitor and self-assess its performance, and can project the likely future state of the environment or its own plans and generate expectations consistent with those projections. Each intelligent object 600 maintains a local world model consistent with its own purview, knowledge, and beliefs. In this exemplary embodiment, such a local world model is designated “My World Model.” The object 600 can accept information from other sources and interpret/analyze the information received to determine whether and how to change its beliefs. This functionality is called situation assessment.

Each object 600 can be configured to have a binding to the physical world, enabling it through sensors or effectors to impact the physical world and be impacted by it. The object 600 affords a service provision interface (I/F) to others, enabling others to acquire services from the object 600. Similarly, if necessary or desired, the object 600 can procure services from others by requesting and procuring these services through its own service procurement interface (I/F). Lastly, the object 600 provides a view/edit/update interface (I/F), enabling users or automated accessors to view and/or modify elements of the object's memory (not shown), including the state information that corresponds to the object's data, information, beliefs, knowledge, and procedures. Intelligent objects implementing the invention would have knowledge and methods that are specialized to particular domains and tasks, such as ground-based traffic analysis, route planning, or driving. Intelligent objects implementing the invention can include or complement other components such as a GPS device or a mobile wireless-enabled personal computer or embedded computer.

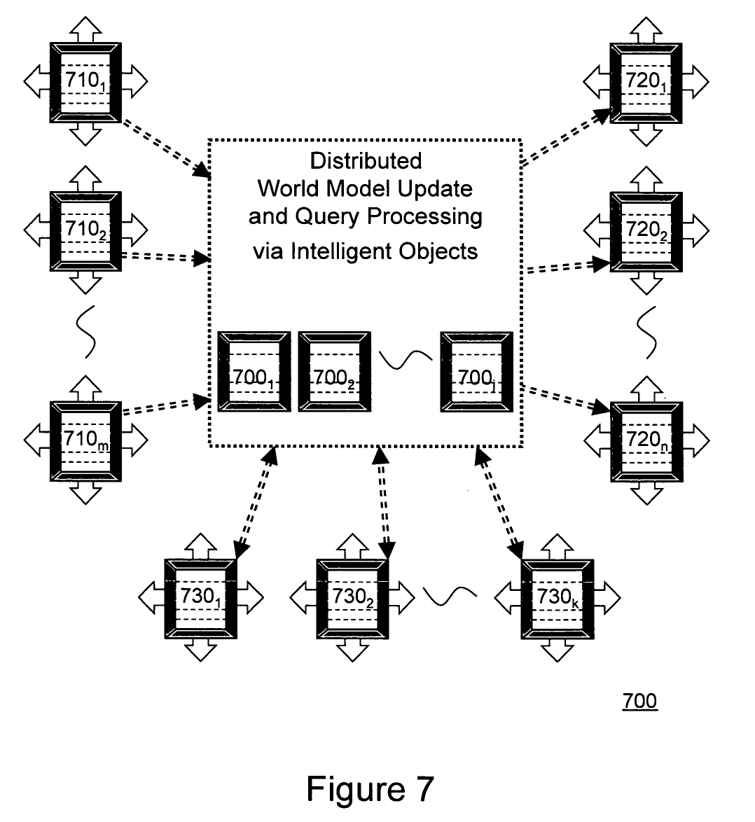

In one embodiment as shown in FIG. 7, specialized intelligent objects are proliferated to support all or many of the individuals and sub-models of the open community model 700. This provides a uniform, scalable, standards-based architecture for the open community model 700. Different domains, tasks, or sub-communities can employ distinct or overlapping sets of intelligent objects. FIG. 7 shows intelligent object suppliers 710₁, 710₂, . . . , 710ₘ, intelligent object consumers 720₁, 720₂, . . . , 720ₙ, and prosumers 730₁, 730₂, . . . , 730ₖ. In the exemplary open community model 700, intelligent objects 700₁, 700₂, . . . , 700ⱼ communicate with and update the distributed sub-models, receive and process queries, deliver requested information, and so on. However, as one skilled in the art would understand, not every consumer, supplier, prosumer, or sub-model necessarily incorporates an intelligent object. These are shown in every role in FIG. 7 to demonstrate that intelligent objects can be universally useful in key roles in an open community model. While XML-defined communications consistent with a DTD would be useful in many implementations, there may be communities that prefer more efficient protocols, and such variety is anticipated.

As discussed above with reference to FIG. 5, in some embodiments a world model is subdivided into separate sub-models and the functions of update and query processing on these sub-models might be physically distributed into different subsystems. FIG. 7 illustrates the extreme version of FIG. 5 where one intelligent object, such as one shown in FIG. 6, is responsible for each atomic sub-model. As an example, we might implement a version of the open community model where each individual is responsible for maintaining the sub-model for its own position and velocity over all relevant time, including into the foreseeable future. This variation takes advantage of local computation close to the sensors to reduce communication and minimize computation that would add no value. For further exemplary teachings on distributed intelligent objects, readers are referred to the following is references:
Hayes-Roth, F., Architecture-Based Acquisition and Development of Software: Guidelines and Recommendations from the ARPA Domain-Specific Software Architecture (DSSA) Program, Teknowledge Federal Systems, 1994.
Hayes-Roth, F. and B. Anderson, Reference Architecture for the Next Generation Controller, Cimflex Teknowledge Corp., Palo Alto, Calif., 1991.
Hayes-Roth, F., L. D. Erman, et al., Tools and Methods for Developing Distributed Intelligent Control and Management (DICAM) Application Systems, Joint Services Guidance and Control Committee (JSGCC) Software Initiative Workshop, Vail, Colo., Meridian, 1992.
Hayes-Roth, F., L. D. Erman, et al., Distributed Intelligent Control and Management (DICAM) Applications and Support for Semi-Automated Development, AAAI-92 Workshop on Automating Software Development, San Jose, Calif., 1992.
Hayes-Roth, F., L. D. Erman, et al., Distributed Intelligent Control and Management: Concepts, methods and tools for developing DICAM applications, SEKE 92: Fourth International Conference on Software Engineering and Knowledge Engineering, IEEE, Capri, Italy, 1992.
Hayes-Roth, F., L. D. Erman, et al., Domain-Specific Software Architectures: Distributed Intelligent Control and Management, IEEE Symposium on Computer-Aided Control System Design, Napa, Calif., 1992.
Hayes-Roth, F., L. D. Erman, et al., Domain-Specific Software Architectures: Distributed Intelligent Control and Management (DICAM) Applications and Development Support Environment, DARPA Software Technology Conference, Los Angeles, Meridian, 1992.
Herring, C. and Hayes-Roth, F., “The DSSA Process Applied to ADS Architecture.” PHALANX, The Bulleting of Military Operations Research, 28(2): 16-23, 1995.
Steeb, R., S. Cammarata, et al., Distributed Intelligence for Air Fleet Control, Rand Corporation, Santa Monica, Calif., 1981.
Wesson, R., F. Hayes-Roth, et al. “Network structures for distributed situation assessment.” IEEE Transactions on Systems, Man and Cybernetics (January), Reprinted in Readings in Distributed Artificial Intelligence, A. Bond and L. Gasser (eds.), Morgan Kaufmann: 71-89, 1981.

According to an aspect of the invention, the availability of wireless communications, such as through an IEEE 802.11b conforming wireless local area network (Wireless LAN), as well as other public accessible networks would enable individuals in the open community to communicate their dynamic state information to anyone they chose. In particular, they could share their information with sub-model brokers who advertise services for making such information available in a particular area. Variants of the open community model can be configured easily to support specialized preferences regarding how data are distributed, aggregated, summarized, or otherwise analyzed and provided by intermediaries to interested individuals. Accordingly, the open community model would be an easy way for a community to provide distributed but aggregated information of interest to all individuals in a local area. Various exemplary implementations of the open community model are described below to illustrate the usefulness and general principles of the open community model disclosed herein.

### Traffic Management

The invention can be utilized in traffic management, where each individual, whether animate or inanimate, supplies information about traffic congestion he/she/it has observed. Each individual exploits the situation/world model to plan traffic routes that minimize expected travel time. As discussed before, various prior art traffic management systems and products exist. Some offer near-real-time traffic alerts. Some allow users to plan routes and evaluate expected times. Some allow users to re-plan or make suggestions about how to re-plan. None of the prior art systems and products, however, offer or anticipate open participation amongst all users. Nor do they adopt standardized semantics that can be easily extended to new concerns with new suppliers and new classes of consumers. Because all previous systems are architecturally closed, they do not anticipate or facilitate the rapid evolution of communities. On the other hand, the open community model disclosed herein allows members of a community to extend easily the range of semantics that they use to exchange information. As described above, the open community model comprises means for correctly and assuredly encoding and interpreting information being exchanged, thereby enabling each community concerned with a domain and task to innovate new types of information with new types of value, which, in turn, enable new types of planning and executing and ultimately achieve the best possible outcomes. This is a change comparable to that wrought by movable type: new categories of value will be experienced through new types of information rapidly defined, produced, exchanged, and reimbursed.

The open community model provides an ideal architecture for addressing land vehicle traffic and other types of traffic problems. For example, individual prosumers can report actual flow rates on particular pathways or route segments. These actual rates can be used to adjust expectations for future flow rates and thus improve the predictions for individual route latencies. As flow rates differ from previous expectations, different routes become optimal, so individuals can benefit from changes in course. The community model thus enables improvements in efforts to optimize traffic flows for individuals or for fleets or for entire communities. This is true regardless of the domain, such as automobile traffic, mass transit, airplane traffic, cargo traffic, and traffic conducted along other lines of communication or conduits. Wherever improved estimates of current and future state would benefit from an open market of information suppliers, the community model affords benefits to traffic management.

The invention further includes devices that offer improved route planning. The devices incorporate continually updated situation models and using these to assess their candidate routes. Intelligent objects can be utilized in every product or vehicle that operates in a dynamic environment. Such intelligent objects are implemented as a software program that combines awareness of one's own position, velocity, planned routes, and expected arrival times at waypoints along a planned route with the ability to update its own world model by use of its own information or information supplied by others. These objects can use or adapt new estimates of parameters such as revised flow rates along a conduit or a route segment to compute new estimates for arrival times and total time en route, for example. This aids the individual in determining whether an alternative route should be taken and in determining more accurate expected rates and arrival times.

In the open community model, individuals are able to supply information about their own positions over time, including future time. This enables the world model to have a more accurate expectation for traffic density and aggregate arrival rates and times. For example, a major entertainment venue might anticipate an excessive surge of traffic earlier than initially planned if thousands of travelers reported arrivals at en route waypoints much earlier than they had planned.

Many variations of such a ground-based traffic management are possible. For example, air traffic management may be improved by use of a more comprehensive, integrative, certain shared community model encompassing key elements such as weather, current and expected traffic flows, open routes, and restricted areas. The sources for these observations can include the air traffic control (ATC) systems, controlling authorities for restricted or special air spaces, pilots, and meteorological agents. Again, existing air traffic management systems are architecturally closed and tightly regulated. Currently, there is no open system in place for each aircraft or pilot, once in flight, to convey plans or expectations or violated expectations to the ATC digitally. The more quality and timely digital information that can be integrated into an open community model, the more able are the planners of air flights to choose optimal routes. The sources of information and the planners may include pilots en route. This way, pilot reports might find their way into machine interpretable community models that could directly inform and affect their GPS, route planning, and flight director systems.

Digital information moves along communication networks that are analogous to ground and air route networks. Similarly, goods and materials move along lines of communication (roads, airways, waterways, railroads, etc.) from points of origin to recipients. Information about the current situation as well as recent and historical performance of traffic plans, lines of communication, transport vehicles, and other participants may have logistic importance to community members. The open community model provides a basis for improving performance, efficiency, predictability, and dynamic adaptability of logistics plans and actual results. All of the benefits that could accrue to route planners would apply in all applications.

### Utility Management

As another example, power plant managers could anticipate abnormally high afternoon demand if thousands of consumer air conditioners reported operating at 8:00 a.m. because for each one that event was judged to be a “surprising event” (e.g., was abnormal, occurred on fewer than 5% of all days). The open community model of the present invention makes it possible for individuals to share with world model applications information that the community or a sub-community deems “interesting” and potentially valuable. By allowing the community to easily employ new types of information, new object classes in the world model, and new approaches by consumers of information, members of the community can correspondingly adapt their planned behaviors and improve their situation assessments. In short, the current invention enables a wide variety of community-enabled adaptive behaviors.

### Resource Management

Preferably, the community model prioritizes information flows to make efficient use of scarce resources. An efficient management attempts to achieve attaining the greatest possible value at the lowest possible cost, perhaps maximizing some combination according to a mathematical objective function. The community model accepts information from consumers about the type of information they value and information about the comparative or numeric value of information. Generally, individuals should value information in direct relation to the information's expected impact on the individual, in terms of change of outcomes achieved as a result of receiving and exploiting the information. For example, an individual should be willing to pay $1.00 for information that has an expected improvement in the individual's outcome of $1.00. Information which is more valuable should receive higher priority when resources are scarce. Preferably, higher priority information is communicated before lower priority information. Information's value is dynamic, so the community model continually reassesses value and priority. The community model may not transmit all information, because resources may be inadequate.

The community model can use similar means to communicate information about information, termed meta-information, as it uses to communicate information about the domain and task of immediate interest to the prosumers. Just as information has value proportionate to its contribution to an expected improvement in plans resulting from the use of that information, meta-information also has value proportionate to its expected contribution to improved outcomes. Meta-information helps improve decisions about the value of information, helping to make smarter prioritization decisions, for example. Preferably, the community model uses XML to describe meta-information and a DTD to describe particular semantics. As such, an individual who wants information about particular entities, in a particular region, at a particular time, can send a message to the world modeling application or to other suppliers describing the entities, the region, and the time of interest. The names, attributes, and value encodings would conform to the DTD. Further, the message could contain meta-information such as the individual's priority for the information, the expected impact or value, and perhaps a price or bounty for the desired information along with specifications for required quality and timeliness. The support for such meta-information makes possible an efficient, open market for information by allowing suppliers and consumers to describe what information they offer or seek, what they ask or bid for supplying it, and additional meta-information regarding the quality of information available or solicited. The use of open standards to describe this meta-information means that the community model is open to innovation at the meta-level, where efforts are expended to achieve optimization of value against cost of information exchange. The current invention makes possible rapid experimentation at this level by assuring that participants can provide meta-information and interpret meta-information semantics consistent with community standards.

Through the use of meta-information and prioritization, the current invention improves information flows among participants. In some embodiments, sources of priority include: magnitude of expected impact on individual plans; aggregate expected impact on community outcomes; magnitude of discrepancy in observed vs. expected values; certainty of information; timeliness of information; costs and opportunity costs of information transmission over a resource-limited network. When resources for communicating, receiving, digesting, or otherwise exploiting information are limited relative to potential communications, the community model prioritizes communications and defers potential communications that do not exceed a threshold of sufficient value and do not rate as high as communications of sufficient priority to warrant communication. The invention integrates information logistics means such as those described in U.S. Pat. No. 6,029,175 for optimizing information flow when information transmission resources are limited.

Intelligent objects and other applications that update world models should incorporate planned or expected behaviors into the expected future values of the parameters and other elements of the model to improve the corresponding estimates of the future state of the environment. For example, if a percentage p of participants in the community plan to utilize a particular route segment S during a time interval T, the community model can be adjusted to estimate the total traffic volume transiting S during T using statistical methods. This enables the community model to reduce errors that would arise from delays in receiving position reports and aggregating them. This also enables the community model to reduce costs or improve outcomes by anticipating that various segments might be over-utilized at particular time intervals relative to alternatives.

### Business Process Planning and Optimization

In the business process arena, an enterprise consists of many different sub-organizations, each one a participant in the overall community. The goals of the community are to perform cooperatively and effectively when given a particular task. To accomplish the task, the community must share a relatively accurate model of how each participant performs. When an overall task is taken on, the plan would incorporate expected performance of each participant, and the expected performance would more accurately reflect reality if past performances were reported and assessed for how well they performed against various objectives, such as being timely and cost effective.

Similar optimization can be applied in the supply chain application area. Utilizing the open community model, a community shares its knowledge of how various suppliers perform under certain circumstances, e.g., when asked to produce and deliver a number of components to a given location with given resources. Each supplier's performance history would be used to inform and improve the model of that supplier's predictable behavior. This would enable a collaborative enterprise to more accurately predict how it could actually perform to meet future requests for overall production.

### Information System Performance Management

Most organizations employ information systems composed of many cooperating units that communicate via networks and collaborate to accomplish tasks. With the open community model, experience with actual performance of individual units would be reported and shared among people and systems that need to plan future behaviors, predict likely performance, determine capacity or resources required to accomplish certain levels of performance, and so forth. In this case, the members of the community model would be agents that would observe and describe how the units performed in the past as well as what the current environment appears to be. These reports would be combined in a community model that would enable other agents to determine how well current plans are expected to perform, how alternative plans or resource allocations are expected to perform, etc. The agents might be human or computer-based. The community model would be the basis for more effective, predictable, reliable, and efficient performance of information technology systems, given various objectives, operating in dynamic environments.

### The Land-Based GPS Transportation Grid

A preferred embodiment of the open community model solves the aforementioned problems related to ground transportation, potentially benefiting everyone who travels by ground. Consider a typical city with a number of lines of communication and corresponding vehicles. The city may have a mass transit rail (e.g., subway) system, a mass transit bus system, a number of limited access multilane thoroughfares, and plenty of surface streets. The corresponding vehicles include railcars, buses, commercial vehicles, passenger vehicles, bicycles, police horses, feet and so on. The simplest way to implement the open community model is to treat every vehicle as a prosumer and every passenger as a prosumer, and to equip every prosumer with a device that enables it to evaluate possible plans (routes, vehicles, times, etc.), to select a best possible plan, to compute expected waypoint times, to monitor actual waypoint times, and to report the prosumer's or device's identification, expected and actual plan results, over time. In an embodiment, such an open community model device integrates a GPS device for receiving and transmitting location information, computer program products for mapping and route planning, and a wireless Internet-enabled device for performing any additional computations and for sending and receiving messages to a world model application.

Each prosumer would intermittently report its observations about the observed velocity of traffic flowing in its direction along its route, as reflected in its own rate of progress relative to its intended rate. The world model application would maintain an evolving estimate of the velocity of traffic flowing in each direction on every route segment. Distinct segments would be differentiated for different lines of communications (conduits) that separate different classes of vehicles. Thus, rates on rail would be different from buses, and pedestrian rates would be further distinct from those, and so on.

The world model would thus have a current statistical estimate of the traffic flow on each route segment. For purposes of efficiency, it would also maintain some higher levels of abstraction, such as average rates between entrances and exits on a freeway or average latencies to cross the entire city from East to West or South to North. The world model application would provide updated information to prosumers in an intelligent and practical way. For example, it would frequently send information about significant changes in or other material information about a particular area to each individual already in or soon to enter that area. It would send information about more distant areas less frequently.

The world model would also offer a few web-based services or web services to prosumers, including evaluations of proposed plans and alerts on executing plans. In the former case, the world model would receive a candidate plan from a prosumer, estimate speeds, latencies, and times of arrival at waypoints, and communicate those results to the prosumer. In the latter case, the world model would continually assess whether changes in its overall model would have a significant impact on the previously computed expectations for an individual prosumer and, where applicable, notify the affected prosumer. In addition, the world model might suggest ways to modify a current plan that is adversely impacted by a recent traffic problem. For example, a sustained blockage along a thoroughfare segment might cause the world model to suggest to a prosumer a detour along surface streets or a longer detour around using alternative thoroughfares. In another example, in evaluating a candidate plan the world model might suggest to a prosumer an alternative mode of transport when it determines that a faster, more pleasant, and/or less expensive alternative exists.

Today's GPS devices generally are not capable of integrating traffic flow data or accepting real-time updates from prosumers. Some GPS devices, such as those by Garmin for aircraft and boats, allow the operator to create flight plans. During execution of the plan, the GPS tracks position, heading, and velocity, and extrapolates estimated time of arrival at waypoints on the route. Each GPS device usually has a user interface that allows the operator to create plans via a semantic editor. These existing GPS devices, however, do not allow the users to make observations or to communicate these observations to a community model. Moreover, they do not allow the individual to receive dynamic updates from a community model. Few new products accept a limited amount of real-time data for alerting or replanning purposes. What is lacking in today's GPS-enabled devices is an open, extensible, standardized, semantically explicit system and mechanism for free flow of information exchange. For these reasons, in the preferred embodiment these functions would be implemented either on the prosumer's personal computing device or on the world model application server, depending on the prosumer's preference and personal configuration. All information communicated would be consistent with a community traffic DTD and exchanged using Internet and W3C standards. In cases where supplier qualifications are vital, as in air traffic management, access to community participation might depend on demonstrated capabilities, licensing, or other appropriate means of quality control. Secrecy, encryption, or other security mechanisms could be employed to limit and assure appropriate access to qualified community participants.

Preferably, other types of information can also be exchanged between the world model and the prosumer. In the case of land-based traffic management, other relevant examples would include: estimated delays in arrival of mass transit vehicles reflecting both earlier deviations from schedule and current traffic flow rates; obstacles or other impediments negatively affecting relevant route segments; surprising opportunities arising from reduced traffic flows or other unusual ameliorations; current or forecast weather expected to have impacts on the plans under consideration or execution; reviews and critiques of alternative plans for important, typical, or currently relevant objectives. Because the community model uses an explicit and extensible semantic model of its information, new types of information can be added whenever new types of goals or objectives arise or whenever new or improved information sources relevant to existing goals are created.

As a further enhancement, preferably the open community model would permit the participation of other suppliers of information, extending beyond travelers and vehicles. For example, the operating authority for the mass transit could provide authenticated revisions to schedules on a dynamic basis. The weather service could provide high-quality near-term forecasts of rain and its expected impact on streets. Bridge operators could report total times for crossing their respective bridges and update the information whenever it changes by more than 5%. Because the world model is preferably an Internet-enabled application, these valuable communications can be sent via email to the world model or can be communicated through another Internet or web service protocol. Moreover, because the open community model employs an explicit DTD to characterize information types and meta-information, a new or augmented DTD can be utilized to immediately extend the class of information processed in the model.

As another enhancement, the world model is preferably distributed into regional sub-models, providing high capacity for reasoning with and communicating about local phenomena with prosumers in a local region. Periodic updates between regional sub-models would maintain logical consistency and coherence across the multiple models without requiring any global database or total integrity at any point. For example, in the San Francisco Bay Area, a first sub-model could be responsible for the Peninsula (the southwestern land mass) and all bridges connecting thereto, a second one for the North Bay and all bridges connecting thereto, a third one for the East Bay and all bridges connecting thereto, and a fourth one for the South Bay. Each sub-model connects to the neighboring sub-model wherever lines of communication transition the boundaries and overlaps redundantly in the case of shared bridges (such as the Golden Gate Bridge belonging both to the Peninsula and North Bay sub-models). Intermittently, connecting models would share their information about points of connection and overlap and would bring their estimates into alignment. They would, for example, combine and average their estimates for both northbound and southbound traffic on the Golden Gate Bridge.

As a further refinement, the community model would provide information on a fee basis. Subscribers might pay a monthly amount to receive periodic updates to their information or might pay a fee per transaction for web services of the world model, as when the world model evaluates a proposed plan or monitors an active plan for problems. The community model might offer royalties on information employed to various suppliers, such as GPS device companies, route mapping companies, or traffic monitoring companies. The community model could assess and rate the quality of information its suppliers provide, and adjust amounts paid by consumers or paid to suppliers based on that quality. The community model could assign different priorities to different consumers, or to different types of impacts that it could cause or forestall. It could prioritize its communications to consumers to achieve higher priority impacts or to avoid low-priority interruptions.

As a further refinement, the community model could qualify or certify its information suppliers. It could then restrict access communications to and from the community model based on these qualifications or certifications. The community model could use standardized meta-information consistent with the meta-information DTD to describe the qualities and certificates of the suppliers and their information.

As a further refinement, the community model would allow wide participation among alternative suppliers of information, using feedback on quality or market feedback to reinforce high performers. As an example, every observer of traffic could be provided with a semantic editor having a web interface that would allow it to make intermittent observations about traffic conditions in the area of interest. The suppliers could offer these at various prices. The community model could assess the quality and price of available information. It could then select among alternative suppliers to offer products of optimized quality per cost to its consumers. It could tailor which suppliers it utilizes in providing services to which consumers, based on each consumer's needs and/or preferences as well as taking into consideration quality and cost factors. The information provided and the meta-information utilized by the community model in the dynamic environment preferably conform to the semantic specifications of the corresponding DTD.

As a further refinement, the community model can provide risk protection to its suppliers and/or consumers, so that these parties would find the risks of participating acceptable. Risks addressed could include privacy, anonymity, erroneous estimates, and legality of data access.

While the disclosure above frequently addresses problems in ground transportation and traffic management, many alternatives and improvements are anticipated. Within the ground transportation arena, the architecture of the community model and the prosumers' equipment can be partitioned in alternative ways and enhanced through device integration. For example, the entire interface could be provided by interactive speech and hand motion gesture, and all of the computation and communication could be provided by integrated capabilities built into the vehicle platform.

Another class of anticipated enhancements/refinements/improvements corresponds to natural differences arising when the community model is adapted for other tasks and domains. In the aforementioned general aviation management example, the plans are for air routes, and many factors can affect viability and desirability of such plans. These factors include visibility, wind, temperature, altitude, precipitation, icing, temporary flight restrictions, notices to airmen (NOTAMS), hazardous weather, mountain obscuration, instrument meteorological conditions (IMC), airport facilities and equipment, equipment outages, pilot reports, etc. In the aviation domain, all of these concerns and corresponding sources of information can be addressed by an appropriate configuration of community model. This community model of the airspace and related phenomena would be shared among planners and en route aircraft to alert them to problems, to evaluate alternatives, and to improve outcomes. In a symmetrical way, each vehicle and pilot could be a supplier of relevant observations. Pilot Reports (PIREPs), for example, could be encoded in XML consistent with a community model DTD and then aggregated and fused for improved situation assessment and automatically supplied to aircraft and pilots who have asked for material information relevant to their active or anticipated planned routes.

All communication and logistics networks can similarly benefit from the same types of services illustrated in the ground and air transportation examples. All of these networks aim to move parcels through spaces along allowable conduits with economic utility associated with the quality and timeliness of deliveries and costs borne to achieve the deliveries. Because collections of deliveries can determine the aggregate utility and costs, the community or members of the community often have objectives to optimize collections of deliveries or revenues from conduits. Whatever the type of parcel, conduit, quality and cost factors apply, the community model invention described here can be employed to permit individual suppliers and consumers of information to participate in the attainment of improved outcomes. By using assessment and compensation methods described here, the community model can further improve the outcomes attained and cause performance improvements in the individuals who are adaptive.

While the syntax is not important, using a community-specific DTD to describe in XML each communication to or from a prosumer enables a community to agree on what data fields can be transmitted, how each of the information fields is denoted, and how each field is encoded. For example, in the ground transportation community model, the DTD could include fields for vehicle or traveler identification (a unique identifier), a time-based position report (consisting, for example, of a UTC time and a latitude-longitude pair) and, optionally, a velocity (e.g., direction, speed, a 90%-confidence upper limit, and a 90%-confidence lower limit). The velocity statistics could be inferred by the world model application but, in general, the community model suppliers will find it easy to provide that kind of information autonomously. A plan would consist of a list of position waypoints and associated expected times, among other assumed and expected conditions the plan is predicated upon. XML is a popular standard for making explicit what data fields will be communicated and how they will be represented. DTDs are a popular technique for communities to agree upon how information will be represented for exchange among the community participants. The community model can be implemented nicely and economically using these well known technologies.

A further refinement of the community model would support continual evolution of the type of information the community employs. In conjunction with feedback and market mechanisms, the type of information should evolve to support improved ways to give consumers timely information that helps them improve their outcomes. For example, it might prove useful for some travelers to have very precise estimates of arrival time, to have low risks of delay, or to traverse specific designated route segments. Newly recognized needs such as these might require alterations or extensions to the DTD used by the community, but it should not be necessary for everyone in the community to alter systems in place. One way to do this is to allow multiple DTDs, each of which has a unique generational index to identify it, and allow suppliers to attach a data field to every message that identifies the DTD employed. Using this or any reasonable alternative, suppliers could offer additional or modified types of information, and consumers who have a need or an interest can access it, employ it, and assess it. Through feedback to the community model and to the suppliers, valued information will be naturally selected and will persist, so that additional users might adopt it over time. Permitting this kind of open-ended evolution is a key objective of the community model.

The community model may combine forward-chaining and backward-chaining types of planning and problem solving. Although these terms are usually applied to rule-based problem-solvers, we extend them here to apply to the open community model in the following way. According to the present invention, information is being processed in a forward mode when prosumers make observations, convey these to a world model, and the world model in turn conveys these to interested individuals. According to the present invention, the process works backward when the goals of the individual consumers drive collection, analysis, and supply of the relevant material information. We have thus far described one type of backward-chaining, i.e., when an individual informs the world model that it wants to have its executing plan monitored so that it could be notified or alerted in case of significant problems. However, as we described it earlier, the world model merely receives and processes traffic updates and then looks to see which plans would be adversely impacted. The community model could drive more backward processing by seeking information that would be material for its consumers. As an example, it could put out a bid for information of a certain type and quality, and offer to pay the first supplier who could provide such information or pay the one who could offer it for the least cost. If many consumers will be affected by the same information, the community model would benefit by aggregating these needs and seeking a qualified supplier. In this way, the community model can stimulate new supplies of innovative information.

The openness of the community model, in terms of which individuals can participate, which information they can supply or desire, how they may access the communication network, how much inference the world model performs, and how the world model state and processing are distributed provides an excellent basis for building an open forum or an open market place in which valued information is exchanged among participants (suppliers, consumers, and prosumers). The efficiency of this open community is determined by the value of information received and utilized by consumers. Their ability to improve outcomes with improved information induces a value for that information. The community optimizes its use of scarce resources by increasing the aggregate value delivered under constrained communication and processing resources. Alternatively, the community optimizes the average value delivered per cost of communication and computation required to utilize the information. Such optimization abilities and hence performance can be further enhanced by increasing the community model's ability to identify high quality information, to identify high impact uses of that information, and to assure that higher value or higher value-per-cost information is transmitted before lower value information.

The community model can accomplish these objectives in several ways. The model can accept feedback from users and use the feedback to adapt estimates of information value for those consumers and estimates of the information supplier's quality. The model can provide feedback and justifications to suppliers, enabling them to learn and improve. The model can cause differential payments to suppliers based on the value and/or quality of their information and thus entice them to improve. The model can employ specifications of needed information and required quality levels specified by interested consumers. It can convey these to suppliers to induce them to provide what is valued. The model can employ computational procedures to analyze consumer's plans, the environment, and statistical patterns of behavior to deduce and infer what types of information are most valuable and to which consumers. It can then seek and provide such information to those consumers. The quality of the community model means that third-party individuals can participate in roles of analysts, forecast impacts, determine information needs, assess plan sensitivities, estimate the value of information, and assess the quality of information and information suppliers. Though neither suppliers nor consumers of the community model, these analysts work at the meta-level, providing information about the information and about the best use of resources. The community model is improved by permitting such meta-level work by these third-party analysts. A community model can also address the same problems directly at the meta-level. That is, a community model preferably would use the techniques of open, Internet-enabled, XML-modeled data communication among qualified suppliers and consumers of meta-information, namely, the information about the value of information for various consumers and the quality of various suppliers at the level of the domain problem being solved, e.g., air route visibility assessment and visual flight rules route planning.

Systems that can reason at the meta-level to achieve enhanced performance at the object level are common in artificial intelligence. While it is true systems could employ multiple levels of meta-reasoning, in practice, a two-level system is usually adequate. In such architectures, a single meta-level above the domain problem-solving level provides an adequate container for all meta-level reasoning. All meta-level reasoning, no matter how many levels above the domain level, can be combined in one overall level that contains reasoning about information quality, information value, priorities, focus of attention, supply, demand, price and resource allocation. Thus, the community model can be extended with a meta-level to allow for the open exchange of meta-information and for the creation of a market that rewards analysts who supply and/or improve upon other prosumer analysts. Meta-level reasoning can be performed in other ways, such as with multiple levels or forced into a single level used for all reasoning; in any case, the same general purposes and benefits are achieved.

As the above examples illustrate, the present invention provides a means for a large variety of communities to employ shared models to improve collective outcomes, tailoring the types of information and means of communication to the problems being solved, the situations being monitored, the plans being generated, and the communication networks employed. The community model provides an innovative way to allow many information suppliers and consumers to contribute to and benefit from a world model that obtains and provides valued information to consumers to help them adaptively achieve the best possible outcomes. Because the community model provides a means for participants to agree on semantics and to extend those semantics as desired, the community model makes an ideal environment for supporting the rapid evolution of types of information, types of information suppliers, and types of adaptive behaviors appropriate to achieving desired outcomes in dynamic environments. Furthermore, the use of open, extensible, Internet and W3C standards, and XML and DTD to convey and describe semantics of information and meta-information means that the community model provides an open environment where suppliers, consumers, and prosumers can evolve increasingly advantageous types of information and meta-information, where this evolution can be shaped by feedback, reinforcement, evaluation, and compensation. Other standards may also prove useful, including ones which supersede these or which are unrelated to the aforementioned standards. Tying resource allocation to the value of information and its relative priority makes the community model an efficient mechanism for overall control of community resources and community problem-solving activities.

What is more, the invention enables individuals to use planning devices that incorporate real time data. The invention enables individuals to employ planning devices that use models of the environment that are more accurate and timely than the general-purpose, static, and inaccurate alternatives. The invention enables individuals who live and travel in a community to share current information. The invention enables the community to define and employ standards for exchanging information of this sort. The invention enables individuals to share information without great difficulty, utilizing both standards and simple supply mechanisms.

The invention enables individuals to receive and exploit a useful and efficient information supply. This information supply has the following advantageous properties:
It reduces uncertainty or error in a variable that, in turn, enables the recipient to make better plans, ones that reduce costs or improve outcomes.
It employs a problem-solving framework that imputes value to various types of information, so that it can supply useful information.
It enables individuals to receive potentially valuable information as well as to receive, digest, and act upon it, thereby reducing their costs or improving their outcomes from what they otherwise would have been.

The current invention provides a means for individuals in a community to share information about their environment continually so each individual can improve the outcomes or reduce the costs associated with its current and planned behaviors.

The current invention employs a problem-solving framework that determines which type of information will be valuable to various individuals.
It determines which individuals can potentially supply that information.
It collects that information from the appropriate suppliers.
It provides that information to the appropriate consumers.

The current invention provides a means for recipients of potentially valuable information to respond appropriately to that information, including receiving and processing that information. It provides means for the recipients to adapt their behaviors in response to the new information so that they improve their expected outcomes or reduce their expected costs. The current invention provides a means for defining standardized forms of information that are associated with different types of information that are relevant to different types of behaviors. This makes community communication more feasible, efficient, and valuable. Overall, the invention makes possible efficient centralized or efficient decentralized implementations, thereby affording wide latitude in how communities share models and exploit them.

As discussed before, the invention can significantly improve traffic management in a wide range of domains, from automobile and air traffic to the logistic management of information or shipping cargo. By increasing the materiality, timeliness, accuracy of information available for utilization, the invention improves the quality of planned routes and the quality of situation models.

The invention also improves information flows when resources are limited so that the highest valued information is most likely to be processed, thereby reducing and even minimizing the consequences of delayed or neglected information. One benefit is that community models can be optimized to trade-off quality of information against cost of information processing. The invention improves expected outcomes by generating expectations about future states through effective use of its available knowledge of individuals' planned behaviors. This achieves better outcomes at lower costs than models which do not anticipate predictable outcomes or which must increase processing capacity and associated costs to rapidly detect and instantaneously respond to the appearance of predictable events rather than merely noting exceptions. The invention provides a means for a large variety of communities to employ shared models to improve collective outcomes, tailoring the types of information and means of communication to the problems being solved, the situations being monitored, the plans being generated, and the information networks employed for communication.

The information flow from the community model's world model to the individual is intended to aid the individual in minimizing costs and improving outcomes. In a simple form of the community model, the model may not know what the individual's planned behavior is, but it might know only where the individual is and has been recently. The model can reasonably infer that the individual is most sensitive to significant changes in the individual's expectations, especially those that are within the envelope of space the individual is likely to be traversing in the near future. Thus, the model can supply information updates to the individual proportional to their degree of change, nearness, and relevance. In cases where space is abstract rather than physical, nearness and relevance and materiality have analogous interpretations. The model can provide more information over time, assuming the recipient doesn't incur significant costs for receiving these and that the community network doesn't have higher priority needs for limited communication bandwidth.

The community model might be informed by the individual of the individual's plan and expected waypoints (progressive positions over time). This enables the model to have a more precise understanding of what types of information will affect the expected costs or outcomes for the individual. Thus, the model can be more precise in estimating the value to the individual of receiving information the model possesses. When resources are limited, this knowledge can increase the value of information delivered to each individual as well as to the aggregate community of individual recipients. The open explicit semantic model means that new concerns can be reflected through quick and easy evolution of the corresponding information or meta-information DTD.

Note that the open community model is fundamentally closed-loop in its fullest embodiment, but need not be “closed” in a literal sense. Individuals can play either or both roles of producing information and consuming information. Individuals can participate in either or both activities of observing/modeling the environment and planning/acting in the environment. The community as a whole can incorporate all of these roles and functions, in any or all regions of the space of interest, and can communicate from and to individuals playing any of these roles in any part of the space. So the open community model is flexible and open in terms of participants and their roles, though in overall concept the community model provides an aggregate closed-loop capability. It is also “open” with respect to platforms and information exchange standards, allowing new types of information and meta-information be introduced continually and allowing new participants to supply and/or consume this new information.

Due to recent advances in information mark-up and meta-data description, it is desirable to support information exchange in community models using XML or similar formalized syntactic language. This permits each community to use editing and communication tools that are widely used by worldwide communities. At the same time, each community can describe its own terms and messages of interest, and the encoded information can be read textually as well as parsed and displayed automatically in a variety of ways. This makes it easy for new communities to begin, for practical standards to be defined and evolved experimentally, and for communication and computation costs to be reduced dramatically. In short, the widespread availability of the Internet and XML makes it simple to initiate community models. In some embodiments, it might be necessary to compile XML-encoded messages into shorter less readable forms, to achieve communication or parsing efficiency. This type of improvement is familiar to many software engineers working on performance-sensitive systems.

It has long been known that information derives its value from its ability to impact outcomes. The converse is also true: information that doesn't impact outcomes doesn't have value. One of the most significant benefits of the community model is that it describes how new categories of information value will be identified and operationalized. Specifically, wherever community models can be implemented as described in this invention, valued information will flow. This means new markets can be established wherever such community models can be economically operated. This means suppliers of innovative information will be able to earn payments for that as they participate in community models that pay for valued goods. This in turn means that innovative supplies of information will come to market to offer consumers new forms of value. Moreover, device makers will see benefits in augmenting their products so that they can participate more fully in such closed-loop but open community models. GPS devices used for position awareness would be improved by incorporating means to receive relevant traffic situation data and recommending improved routes to their operators, as one example. In a related example, the same devices could be improved by transmitting their positions, speeds, plans, expectations, and noted exceptions to expectations to the community model. Participants in this information supply could be enticed to participate, through a royalty sharing plan where consumers pay for valued information from the community model and the community model, in turn, pays for information valued.

The community models can improve their ability to deliver valued information by having an accurate and operational understanding of the type of computation necessary for the individuals who receive their information to derive value from it. For example, if the individual receiving information is a GPS route planner embedded in a moving vehicle, information conveyed can be optimized when the sender knows what information needs to be transmitted in what format. Continuing the example, the model might know that the recipient is traveling for the next 60 miles at expected 65 mph along Interstate 80 Eastbound. If the information available is about a 2% change in attainable maximum velocity, the model could send the new maximum velocity and a flag indicating that it is a relatively small change. This would enable the recipient to defer detailed analysis of impact if it had high priority tasks to do. On the other hand, if the model is aware of an impending complete blockage of highway I-80, it could cause a high priority warning alert to be transmitted, causing the on-board route planner to look for detours. Depending on the ideal distribution of planning capabilities, the community model might develop its own expectations for optimal routes that by-pass the trouble, and disseminate these to affected participants. The more the community model knows about how the outcomes of the tasks underway by the individuals will be affected by its changed situational information, the better it can communicate and assist in the efficient processing of the information.

In sum, the community model provides an innovative way to create valued information, by linking producers and consumers in the process of constructing, updating, and exploiting a community model of the environment to enable individuals to reduce costs and improve outcomes resulting from their behaviors in that environment. The community model can be implemented in small or large domains, with single or multiple types of behaviors, with few or many participants, with participants playing limited or diverse roles. Thus, the community model can be a source of innovative information markets in a wide variety of arenas. It can be fully automated, where the producers and consumers of information and the community modelers are implemented as computer systems. Alternatively, any or all of the functions of the community model can be achieved by living systems, especially humans.

The community model may be implemented in a distributed system so that no central source of information is available. The world modeling function can be distributed and can be implemented by a plurality of intelligent objects that utilize new information to assess how it affects the situation and then update the corresponding sub-model of the world model. The intelligent objects can interact with one another through Internet protocols, such as web services, or other means for procuring and supplying services in interaction with other objects. The availability of the Internet and protocols like XML and other W3C protocols for sharing information makes it easy for communities to implement a community model. The community model is easily specialized to different domains and tasks, requiring only that there be agreement on the DTD and some application that can utilize information to update a world model information base and that some application is able to provide information to relevant individuals from the world model information base that answer their queries, match their interests, or otherwise materially impact their outcome in positive ways. Because DTDs can be easily changed and evolved, the community can employ a series of increasingly fruitful DTDs reflecting the experience and innovation of the community to date. The open community model enables individuals to obtain best possible outcomes by closing a loop from the consumer of information responding to updates about the environment model, which result from updates provided by individuals operating in and monitoring the environment. The open community model can estimate the value of information to the individuals operating in the environment and improves that estimate with increased knowledge of the individuals' expectations and the impact of changes in the environment on those expectations. The open community model can model the information and meta-information it operates on and allow open participation with these information models, providing assurance that all participants accord with the prescribed standard models.

Although the present invention and its advantages have been described in detail, it should be understood that the present invention is not limited to or defined by what is shown or described herein. Known methods, systems, or components may be discussed without giving details, so to avoid obscuring the principles of the invention. As it will be appreciated by one of ordinary skill in the art, various changes, substitutions, and alternations could be made or otherwise implemented without departing from the principles of the present invention. For example, although one of the advantages of the open community model is that potentially any contributor can supply information by conforming to the DTD, and potentially any beneficiary can exploit the information by accessing it, interpreting it correctly, and exploiting it, the “openness” relates to the information encoding standards and needs not be literal with respect to participants. As discussed herein, non-qualified participants can be excluded in an open-yet-exclusive type of open community model, which can be useful in preventing unwanted information such as spam from entering the community. One of ordinary skill in the art will also recognize that any digital computer system can be readily programmed or otherwise configured to perform the functions of the open community model disclosed herein. Once they are programmed to perform particular functions pursuant to instructions from computer program products that implement the present invention, such digital computer systems in effect become open community model computing devices particular to the invention disclosed herein. The techniques necessary to achieve this are well known in the art and thus are not further described herein. Computer programs such as those that would implement the open community model are commonly distributed to users on a computer-readable medium such as floppy disk or CD-ROM and are often copied to a hard disk or other storage medium. When such a program of instructions is to be executed, it is usually loaded either from the distribution medium, the hard disk, or other storage medium into the random access memory of the computer, thereby configuring the computer to act in accordance with the open community model methods disclosed herein. All these operations are well known to those skilled in the art and thus are not further described herein. Thus, examples and drawings disclosed herein are for purposes of illustrating a preferred embodiment(s) of the present invention and are not to be construed as limiting the present invention. Accordingly, the scope of the invention should be determined by the following claims and their legal equivalents.

What is claimed is:

1. A system for distributed monitoring and estimation of traffic flow, said system comprising:
an application for maintaining a land-based transportation model having a plurality of transportation routes and a plurality of parameters related to traffic flow in said transportation routes, wherein said parameters are used to statistically estimate the velocity of current and expected traffic in said transportation routes; and
a plurality of prosumers capable of exchanging information with said application, wherein said information is related to traffic flow along said transportation routes, wherein each of said prosumers has a wireless device communicatively connected to said application, and wherein said wireless device allows the same prosumer to report said information related to traffic flow experienced by the same prosumer to said application,
wherein said application combines said information reported by said plurality of prosumers and updates said transportation model based on said combined information from said prosumers, wherein said updating comprises changing said parameters of said transportation model, wherein said parameters are related to speeds and latencies in said transportation routes, and wherein said application sends information related to said updated transportation model to said prosumers.

2. The system as set forth in claim 1, wherein said wireless device of each of said prosumers allows the same prosumer to:
(i) evaluate one or more possible transportation plans;
(ii) select one of said possible plans; and
(iii) send said selected plan to said application,
wherein said application evaluates said selected transportation plan, estimates expected waypoint times along said plan, and communicates said expected waypoint times to the same prosumer.

3. The system as set forth in claim 2, wherein said wireless device of each of said prosumers can monitor actual waypoint times and report said actual waypoint times to said application, and wherein said application updates said transportation model based on said actual waypoint times.

4. The system as set forth in claim 2, wherein said application suggests an alternate plan to one of said prosumers.

5. The system as set forth in claim 1, wherein said wireless device of each of said prosumers allows the same prosumer to:
(i) evaluate one or more possible transportation plans;
(ii) select one of said possible plans;
(iii) compute one or more expected waypoint times, wherein said expected waypoint times are computed based on said updated parameters provided by said application; and
(iv) monitor one or more actual waypoint times.

6. The system as set forth in claim 1, wherein said information exchanged between said prosumers and said application comprises impediments that negatively affect traffic flow along said transportation routes.

7. The system as set forth in claim 1, wherein said information exchanged between said prosumers and said application comprises current or expected weather.

8. The system as set forth in claim 1, wherein each of said prosumers has a GPS device, wherein said GPS device receives location information of the same prosumer, wherein said location information is transmitted to said application, and wherein said application updates said transportation model based on said location information of each of said prosumers.

9. The system as set forth in claim 1, wherein said transportation model comprises a plurality of distributed regional submodels.

10. The system as set forth in claim 1, wherein said transportation routes of said transportation model comprises a mass transit rail system, a mass transit bus system, multiple limited access thoroughfare, and multiple streets.

11. The system as set forth in claim 1, wherein said parameters of said transportation model include speeds and latencies in said transportation routes for each of a plurality of different vehicle classes, and wherein said vehicle classes comprise mass transit vehicles, railcars, buses, commercial vehicles, passenger vehicles, and bicycles.

12. The system as set forth in claim 1, wherein said information exchanged between said prosumers and said application is in XML format.

13. A system for distributed monitoring and estimation of traffic flow, said system comprising:
an application for maintaining a land-based transportation model having a plurality of transportation routes and a plurality of parameters related to traffic flow in said transportation routes, wherein said parameters are used to statistically estimate the velocity of current and expected traffic in said transportation routes; and
a plurality of prosumers, wherein each of said prosumers has a GPS device and a wireless device, wherein said GPS device receives location information of the same prosumer, wherein said wireless device is for communication between the same prosumer and said application, and wherein said wireless device intermittently reports said location information and traffic information experienced by the same prosumer to said application,
wherein said application aggregates said location and said traffic information reported by said plurality of prosumers and updates said transportation model based on said aggregated information, wherein said updating comprises changing said parameters of said transportation model, wherein said application identifies changes to the traffic flow in an area where one of said prosumers is in or soon to enter based on said updated transportation model, and wherein said traffic flow changes are sent to the same prosumer.

14. A system for distributed monitoring and estimation of air traffic flow, said system comprising:
an application for maintaining an air-based transportation model having a plurality of air routes and a plurality of parameters related to traffic flow in said air routes, wherein said parameters are used to statistically estimate the velocity of current and expected traffic in said air routes; and
a plurality of prosumers capable of exchanging information with said application, wherein said information is related to traffic flow along said air routes, wherein each of said prosumers has a wireless device communicatively connected to said application, and wherein said wireless device allows the same prosumer to report said information related to traffic flow experienced by the same prosumer to said application,
wherein said application combines said information reported by said plurality of prosumers and updates said transportation model based on said combined information from said prosumers, wherein said updating comprises changing said parameters of said transportation model, wherein said parameters are related to speeds and latencies in said air routes, and wherein said application sends information related to said updated transportation model to said prosumers.

15. The system as set forth in claim 14, wherein said wireless device of each of said prosumers allows the same prosumer to:
(i) evaluate one or more possible transportation plans;
(ii) select one of said possible plans;
(iii) send said selected plan to said application,
wherein said application evaluates said selected transportation plan, estimates expected waypoint times along said plan, and communicates said expected waypoint times to the same prosumer.

16. The system as set forth in claim 15, wherein said wireless device of each of said prosumers can monitor actual waypoint times and report said actual waypoint times to said application, and wherein said application updates said transportation model based on said actual waypoint times.

17. The system as set forth in claim 15, wherein said application suggests an alternate plan to one of said prosumers.

18. The system as set forth in claim 14, wherein said wireless device of each of said prosumers allows the same prosumer to:
(i) evaluate one or more possible transportation plans;
(ii) select one of said possible plans;
(iii) compute one or more expected waypoint times, wherein said expected waypoint times are computed based on said updated parameters provided by said application; and
(iv) monitor one or more actual waypoint times.

19. The system as set forth in claim 14, wherein said information exchanged between said prosumers and said application comprises current or expected weather.

20. The system as set forth in claim 14, wherein said parameters of said transportation model is selected from the group consisting of visibility, wind, temperature, altitude, precipitation, icing, flight restrictions, notices to airmen, hazardous weather, mountain obscuration, instrument meteorological conditions, airport facilities, equipment outages, and pilot reports.
